(19) United States
(12) Patent Application Publication
(10) Pub. No.: US 2024/0316855 A1
(43) Pub. Date: Sep. 26, 2024

(54) MOLDING TOOL FOR PRODUCING MOLDED PARTS AND METHOD FOR PRODUCING MOLDED PARTS USING A MOLDING TOOL

(71) Applicant: Kiefel GmbH, Freilassing (DE)

(72) Inventors: Johannes Marius van der Schans, Sprang-Capelle (NL); Cornelis Hendrikus Albertinus Decoz, Sprang-Capelle (NL)

(21) Appl. No.: 18/609,725

(22) Filed: Mar. 19, 2024

(30) Foreign Application Priority Data
Mar. 20, 2023 (DE) 10 2023 106 953.5

(51) Int. Cl. B29C 51/08; B29C 51/34

(52) U.S. Cl. CPC B29C 51/085; B29C 51/343

(57) ABSTRACT

A molding tool and a method for producing molded parts from a moldable material with a first tool component and a second tool component are described. The first tool component has a cavity with a first molding surface and the second tool component has a second molding surface and a flexible material forming at least one portion of the second molding surface. In a first step, a moldable material is introduced into the cavity and then the second tool component is moved into the cavity. A second molding surface of the second tool component moves the moldable material in regions against the first molding surface. Thereafter, overpressing of the second tool component takes place after reaching a bottom dead center within the cavity, whereby the flexible material is deformed and presses the moldable material against a corresponding portion of the first molding surface.

### PRIORITY CLAIM

The present application claims priority under 35 U.S.C. § 119 to German Patent Application No. DE 10 2023 106 953.5, filed Mar. 20, 2023, the disclosure of which is incorporated by reference herein in its entirety.

### TECHNICAL FIELD

A molding tool for producing molded parts made of a moldable material and a method for producing molded parts made of a moldable material using a molding tool are described. For example, films made of plastics material, films with openings (for example, net-like structure) and/or fiber-containing materials can be used as a moldable material.

### DESCRIPTION OF RELATED ART

For shaping and/or compressing moldable materials, molding tools are generally used, wherein the moldable material is introduced into a cavity and is deformed there using pressure or by generating overpressure or negative pressure in the cavity or a molding chamber. An introduction of gas/gas mixture (e.g. air) into the cavity or the generation of a vacuum are used in conventional thermoforming. In this case, for example, a film in the cavity is either pressed by the overpressure against a molding wall of the cavity or a film is suctioned to the molding wall of a cavity.

When molding molded parts made of a fiber-containing material, the material is generally introduced and compressed there between molding surfaces of a molding tool, wherein, in contrast to shaping in the case of films, a reduction in the wall thickness or thickness of the preform to be pressed takes place at a simultaneously very high temperature (>200° C.). For example, a preform that differs from the product to be produced with regard to moisture, shape, size, and strength/thickness can thereby be introduced into the cavity. Furthermore, loose fibers can also be introduced into a cavity and compressed between the molding surfaces of a molding tool.

Various tool designs are therefore always required for shaping the different materials. In addition, the corresponding tool designs have different disadvantages. The shaping for products is thus greatly limited, for example, with regard to undercuts and edges at the bottom of the products. In the prior art, products formed in this way can be produced only with a high effort and complex molding tools that have a plurality of movable components. Furthermore, it is not possible, for example, with conventional thermoforming tools to shape films with openings, for example, a net-like structure, since an overpressure or negative pressure cannot provide any deformation in the cavity because the air introduced or suctioned through the openings leads to a pressure equalization on both sides of the film.

Furthermore, in conventional thermoforming, it is necessary to provide overpressure or negative pressure in order to deform a film.

### SUMMARY

### Object

In contrast thereto, an object of the present disclosure is to specify a solution for producing molded parts from a moldable material which eliminates the disadvantages of the prior art and in which a deformation is achieved by simple means with simultaneously reduced use of aids, which deformation is not subject to restrictions with regard to the shape of the molded parts to be produced.

### Solution

The object mentioned above is achieved by a molding tool for producing molded parts made of a moldable material with at least one first tool component and at least one second tool component, wherein
the first tool component has a cavity, into which moldable material can be introduced,
the second tool component can be introduced into the cavity of the first tool component to produce a molded part,
the second tool component has a second molding surface, via which material moldable in the closed state of the molding tool can be pressed against a corresponding first molding surface of the cavity of the first tool component, and
the second tool component has at least partially a flexible material which forms at least one portion of the second molding surface, wherein the flexible material can be deformed in the closed state of the molding tool by overpressing of the second tool component after reaching a bottom dead center in the cavity in order to press the moldable material against the first molding surface.

By means of the molding tool, it is possible, for example, to deform a film made of a plastics material without generating negative pressure or overpressure, wherein a stretching of the film takes place before shaping, analogously to conventional thermoforming processes. In the prior art, a stretching aid or a molding punch is provided for this purpose. The stretching aid presses the film into a cavity, but without pressing the film against the shaping inner wall of the cavity. The final shaping by pressing the film against the shaping inner wall takes place in the prior art by generating negative pressure between the film and the shaping inner wall of the cavity or by generating overpressure between the film and the stretching aid. Due to the formation of the second tool component, the solution described herein allows a film to stretch, wherein no final shaping can take place. Only upon overpressing is the film pressed completely against the shaping inner wall of the cavity, i.e. the first molding surface, wherein the flexible material is deformed by the overpressing and thus provides the molding pressure for the film.

With such a molding tool, for example plastics material with a net-like structure can also be deformed since the shaping takes place without generating negative pressure or overpressure. Via the second tool component, a film with a net-like structure can first be brought into the cavity of a first tool component corresponding to a preliminary stretching and then a deformation of the flexible material can be achieved by the overpressing of the second tool component, whereby the film is pressed against the shaping first molding surface in the cavity.

A further field of application for a molding tool designed in this way comprises the production of molded parts made of a fiber-containing material. Such a molding tool can be used, for example, both for compressing dry fibers (“dry fiber”) and a moist preform (“wet fiber”). A moist material as a moldable material is present from a water content of about 30 wt. %. A material having a water content of less than 30 wt. % is referred to as a dry material.

In the production of molded parts made of a fiber-containing material, fiber-containing material can first be introduced into the cavity, wherein a fiber layer is placed against the first molding surface. Placing the fiber layer can also be supported by introducing the second tool component, which presses the fibers against the first molding surface. Subsequently, overpressing of the second tool component takes place, wherein compressing of the fiber layer takes place. The flexible material of the second tool component is deformed by the overpressing. The deformation then leads to a reduction of the distance between the first molding surface and the surface of the second tool component, so that the fiber layer is compressed. The fiber layer is compressed so that a connection of the fibers can be achieved. In further embodiments, water can additionally or alternatively be pressed out during overpressing by the compression of the fiber material.

Depending on the design of the second tool component, the second molding surface can, for example, have a flexible material only in regions, so that a deformation of the second molding surface takes place only in regions in the cavity, i.e. that pressing or additional pressing of a film or of a fiber material only occurs in corresponding regions of the first molding surface.

In further embodiments, the cavity can have at least one undercut and the moldable material can be pressed into the undercut of the cavity by the flexible material of the at least one portion by means of overpressing of the second tool component. In such embodiments, for example, a film or a fiber material can be deformed between the first molding surface and the second molding surface, i.e. the film or the fiber material is pressed against the first molding surface by the second molding surface. When the bottom dead center is reached, the film or the fiber material rests against the first molding surface except for the region with the undercut. The second tool component is then overpressed, so that the flexible material of the second tool component, which is located at the height or in the region of the undercut, is deformed and thereby pushed into the undercut. The film or the fiber material is thus pressed into the undercut. A tool designed in this way makes it possible in a simple manner to form undercuts in molded parts without moving elements, such as sliders and the like which must be displaced in the molding direction or transversely thereto.

In further embodiments, the at least one portion of the second molding surface with the flexible material at the bottom dead center of the second tool component can be opposite to a region of the first molding surface with the at least one undercut.

In further embodiments, the second molding surface can at least partially have openings. The openings can have different functions for the different fields of application. For example, in the production of molded parts from a moist, fiber-containing material, it is thereby possible to extract water vapor. For this purpose, it can be provided that the fiber material is heated within the cavity by the first molding surface. The first molding surface and the first tool component can be made of a thermally conductive material, such as a metal or a metal alloy, or have such a metal alloy, wherein heating can take place via heating apparatuses in the first tool component.

In further embodiments, a pressure compensation can be provided via the openings in the second molding surface, so that an “air cushion” or the like does not occur when the cavity is closed. This applies to applications for producing molded parts from a fiber-containing material (wet and dry), and for producing molded parts from a film (plastics material).

In yet further embodiments, an introduction of a gas or gas mixture (for example, air) or an extraction of a gas or gas mixture can also take place via the openings. For example, only one region of the second molding surface can have a flexible material which is deformed during overpressing. To ensure that the film is pressed against the first molding surface even in the regions of the second molding surface without flexible material, air, for example, can be introduced via the openings in the second molding surface so that an overpressure in the region between the film and the second molding surface is generated in regions, whereby the film in turn is pressed against the first molding surface in the overpressure region. In the region of the second molding surface with the flexible material, an undercut can be formed in the first molding surface. The flexible material is thus deformed by the overpressing and the film is pressed into the cavity.

In further embodiments, a molding element of the second tool component that is inserted into the cavity of the first tool component can be made completely of a flexible material. Such an embodiment can be used, for example, for molding molded parts made of a fiber-containing material. In this case, the fiber-containing material within the entire cavity can first be pre-pressed by the molding element that is inserted, which serves as a molding punch, in a first step until the bottom dead center is reached. After the overpressing, the pre-pressed fiber-containing material is then additionally compacted by deformation of the flexible material, because the flexible material, depending on the geometry and design of the molding element that is inserted and the geometry and design of the cavity or the first molded surface, further compresses the fiber-containing material through deformation of the flexible material. In this case, the pre-pressed fiber-containing material can be further compressed, for example, in certain regions, so that molded bodies can be manufactured with varying wall thicknesses.

Furthermore, in further embodiments, the fiber-containing material can be compressed until the bottom dead center is reached, and fiber-containing material can be pressed into an undercut only by overpressing.

For the above embodiments, the molding element that is inserted can thus have a shaping surface which serves to mold the material introduced into the cavity, which material completely is or has a flexible material.

In further embodiments, a molding element of the second tool component that is inserted into the cavity of the first tool component can be solid or designed as a hollow body. A solid molding element can, for example, be made completely of a flexible element and be connected to a punch which is not deformable during overpressing and serves for moving the molding element and for compressing. Such a punch can, for example, be made of metal or a metal alloy. In further embodiments, the punch can be connected and coupled to further punches of a tool arrangement, so that compressing and overpressing can take place simultaneously for a certain number of tools. A molding element as a hollow body also has a punch which is used for moving the molding element and for compressing. The punch can have struts or other elements which provide a connection to a shell made of the flexible material. In the connection regions between struts, etc. and the flexible material, a deformation of the flexible material during overpressing can be stronger or weaker, so that this also significantly influences the deformation of the flexible material in order to achieve a definable result for a molded part.

In further embodiments, the molding element can have internal support structures for this purpose.

In further embodiments, the support structures can influence a deformation of the second molding surface during overpressing. The support structures can, for example, hold a shell of flexible material and thus also influence the deformation of the flexible material and the deformation/movement of the flexible material when there is a pressure on the flexible material.

In further embodiments, the entire second molding surface can have a flexible material which surrounds an inner core made of a non-deformable material. The non-deformable material can be, for example, a metal or a metal alloy which is connected to a punch made of the same non-deformable materials. The inner core is surrounded by the flexible material. While compressing the moldable material, the flexible material is supported by the inner core, so that an evasive movement of the flexible material cannot occur into the interior of the second tool component or of a molded part that is inserted in the cavity. Due to the design (material and structure) of the flexible material, it can only be deformed when the bottom dead center is reached and the overpressing takes place.

In further embodiments, the flexible material can have reinforcements and/or weak points which influence the deformability of the flexible material during overpressing. Reinforcement can be, for example, struts or the like introduced into the flexible material, which require a higher pressing force for a deformation than the flexible material, so that, for example, the deformation of the flexible material in the region with the reinforcements begins later than in the remaining region or is not as strongly pronounced as in the remaining region. Weak points in the flexible material can be gas or gas mixture inclusions, for example. Furthermore, weak points can also be portions in which the flexible material has a low thickness (wall thickness) compared to other regions. Notches on the inner and/or outer side can also form weak points. For this purpose, reinforcements can be specifically regions which have a greater wall thickness, for example. The material selection and composition can also influence the deformability of the flexible material.

In further embodiments, the flexible material can be made of different materials which differ with regard to the deformability of the flexible material during overpressing. Different deformations and ultimately different designs of molded parts can thus be realized.

In further embodiments, the second molding surface can have at least two portions of a flexible material which differ in terms of the deformability of the flexible material during overpressing. In this case, the materials can be selected, for example, depending on the formation of undercuts, etc., so that sufficient deformation of the flexible material takes place in order, for example, to press the moldable material into undercuts of different depths and widths. The position of the undercuts can also be decisive for this purpose, for example in the case of molded parts which taper conically upward.

In further embodiments, the flexible material can include or be made of silicone and/or thermoplastic elastomers. Depending on the required deformation due to the geometry and design of a molded part and the resulting geometry and shape of a cavity or of the first molding surface, differently strongly deformable materials can be used. It is also to be taken into account in the selection of flexible materials whether the moldable material is compatible with the flexible material, so that no damage or impairment of the moldable material and of the flexible material occurs. In addition, it must be taken into account which temperatures the flexible material is exposed to. In particular in the production of molded parts from a moist, fiber-containing material, the fiber material is often additionally heated during compressing. Corresponding silicones and thermoplastic elastomers are therefore to be selected. For example, a temperature resistance can be required for the flexible material of up to 300° C.

In further embodiments, the first molding surface can have second openings, through which water vapor generated during compressing and with a simultaneous supply of heat can be extracted or discharged.

In further embodiments, the first tool component and/or the second tool component can be heatable by at least one heating device, so that, for example, the moisture of fiber-containing material can be reduced and/or the connection of fibers can be improved or supported. Films made of plastics materials can also be more easily deformed in further applications under the effect of heat. Heating devices can comprise, for example, heating cartridges, inductive heating devices, etc.

In further embodiments, the first molding surface can have second openings, through which water vapor generated during compressing and with a simultaneous supply of heat can be extracted or discharged.

The above object is also achieved by a method for producing molded parts from a moldable material using a molding tool having at least one first tool component and at least one second tool component, wherein the first tool component has a cavity with a first molding surface, and wherein the second tool component has a second molding surface and at least partially a flexible material which forms at least one portion of the second molding surface, having the following steps:
introducing a moldable material into a cavity of at least one first tool component,
introducing a second tool component into the cavity of the at least one first tool component by relative displacement of the at least one first tool component and at least one second tool component, wherein a second molding surface of the at least one second tool component moves the moldable material at least in regions against the first molding surface, and
overpressing of the at least one second tool component after reaching a bottom dead center within the cavity, whereby a flexible material forming at least one portion of the second molding surface is deformed, and by means of the deformation the flexible material presses the moldable material against a corresponding portion of the first molding surface.

The method allows for molded parts to be produced and structures to be formed in a molded part with simple means, wherein a deformation of the flexible material takes place by means of the overpressing, which leads to an additional shaping of the moldable material. The embodiments and advantages specified above for the molding tool apply accordingly to the method described herein.

In further embodiments, the cavity can have at least one undercut, wherein the moldable material is pressed into the undercut of the cavity by the flexible material of the at least one portion of the second molding surface during overpressing. A two-stage production method is thus provided, which is characterized in contrast to known methods in that a pressure is exerted solely by the second tool component. It is thus not necessary to move and control further shaping tool parts.

In further embodiments, after the molded part has been molded in the cavity, the overpressing can be ended, whereby the flexible material once again assumes its shape that was present before the overpressing and then the at least one second tool component is moved out of the cavity.

Further features, embodiments and advantages result from the following illustration of exemplary embodiments with reference to the drawings.

### BRIEF DESCRIPTION OF THE DRAWINGS

In the drawings:

FIG. 1 depicts a schematic representation of a molding device for producing molded parts from a moldable material, according to some embodiments.

FIG. 2 depicts a schematic representation of a molding tool for producing molded parts, according to some embodiments.

FIG. 3 depicts a schematic representation of the molding tool from FIG. 2 after the introduction of a moldable material, according to some embodiments.

FIG. 4 depicts a schematic representation of the molding tool from FIG. 2 in a first molding step, according to some embodiments.

FIG. 5 depicts a schematic representation of the molding tool from FIG. 2 after a second molding step, according to some embodiments.

FIG. 6 depicts a schematic representation of a molding tool of a further embodiment, according to some embodiments.

FIG. 7 depicts a schematic representation of a molded part, according to some embodiments.

FIG. 8 depicts a schematic representation of a second tool component of a molding tool in yet further embodiments, according to some embodiments.

FIG. 9 depicts a method for producing a molded part, according to some embodiments.

### DETAILED DESCRIPTION

Various embodiments of the technical teaching described herein are shown below with reference to the figures. Identical reference signs are used in the figure description for identical components, parts and processes. Components, parts and processes which are not essential to the technical teachings disclosed herein or which are obvious to a person skilled in the art are not explicitly reproduced. Features specified in the singular also include the plural unless explicitly stated otherwise. This applies in particular to statements such as “a” or “one.”

The figures show exemplary embodiments of apparatuses for producing molded parts from a moldable material, wherein the exemplary embodiments shown represent no limitation with regard to further designs and modifications of the described embodiments.

The production of molded parts 200 from a moldable material is described below, wherein a fiber-containing material is used as the moldable material. The fiber-containing material can be both a dry fiber material and a moist or wet fiber material. The term dry fiber material is generally used for a water content of less than 30 wt. %. In the case of a water content of about 30 wt. % or more, it is referred to as moist fiber material. The fiber material can thereby be present as a preform and can be further processed in a molding tool 30. Alternatively, fiber material without a structure or the like can be introduced into a cavity 36 of a molding tool 30 and can be molded there into a molded part 200. Preforms generally already have substantially the shape of the molded part 200 to be produced. In particular, fiber-containing material can have only natural fibers.

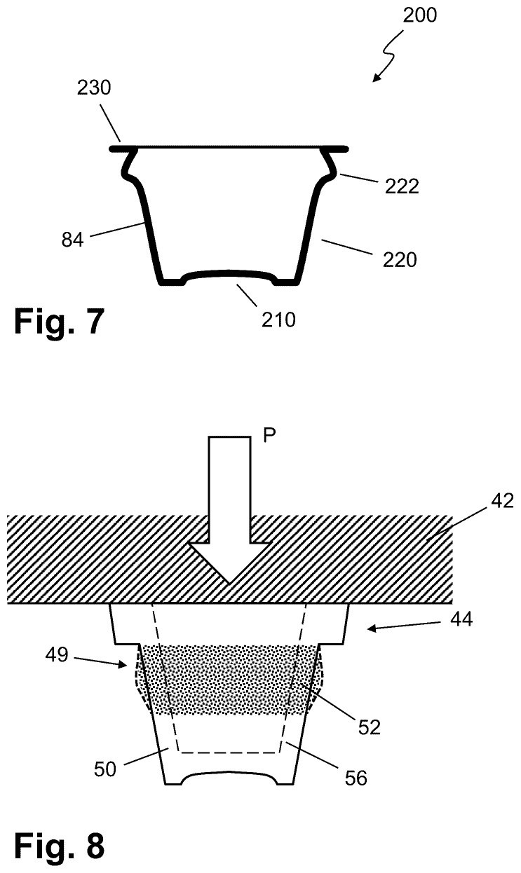

A molded part 200 can in particular be a three-dimensional molded part 200, such as, for example, cups, lids, bowls, capsules, plates, and further molded and/or packaging parts (for example, as holding/support structures for electronic or other devices). The fiber-containing material can further have additives which affect the mechanical properties and the barrier effect. According to the composition of the fiber-containing material, molded parts produced from a fiber-containing, moldable material can be biodegradable and themselves serve as a starting material for producing three-dimensional molded parts, such as, for example, a cup-like molded part 200 (see FIG. 7), from a fiber-containing material and be composted, because these can generally completely decompose and do not contain any toxic, environmentally hazardous substances.

Instead of a fiber-containing material, films can also be shaped using the molding tools 30 shown in the figures. In particular, the special design of a molding element 44 that is inserted into the cavity 36 of a first tool component 32 enables, with a simple structure and a simple design of the molding tool 30, the formation, for example, of undercuts 38, etc., without requiring, for example, additional slides or the like. In addition, in further embodiments, the design of the molding tool 30 also allows for the production of molded parts from a film which has a net-like structure, because it is not required to introduce “molding air” or generate a vacuum, as is necessary in conventional thermoforming tools and methods.

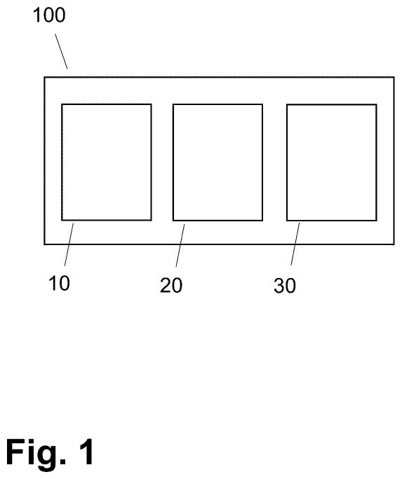

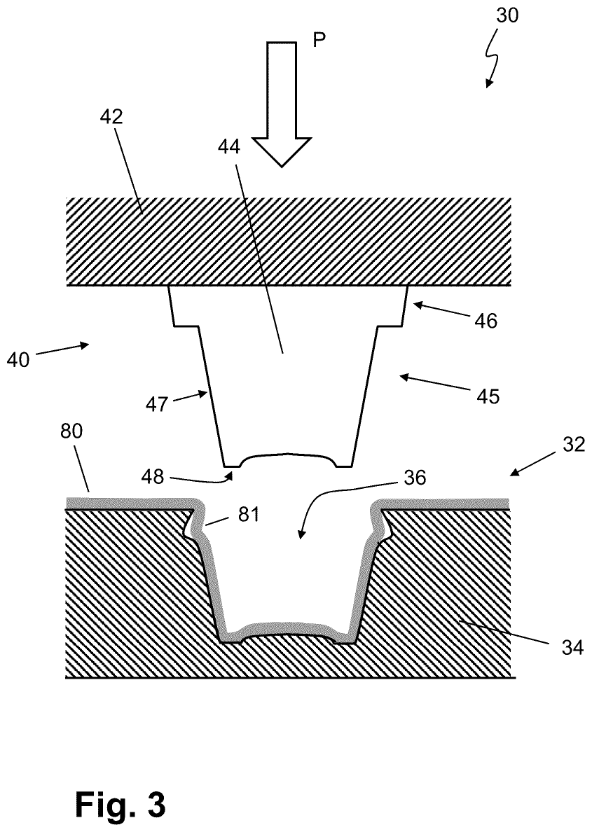

FIG. 1 shows a schematic representation of a molding device 100 for producing molded parts 200 from a moldable material, according to some embodiments. The molding device 100 has at least one controller 10, a supply device 20, and a molding tool 30 for molding a moldable material. The controller 10 serves to control the processes and procedures of the molding device 100 and is connected to the corresponding devices for this purpose. The controller 10 regulates the required energy and material conversion and processes information and control commands for this purpose. The supply device 20 serves to supply moldable material, for example, fiber-containing material, which is introduced either as a preform, as a fiber mat or as a loose fiber material via the supply device 20 into at least one cavity 36 of at least one molding tool 30. In further embodiments, the fiber-containing material can be moistened in order to improve the bonding effect between the fibers of the fiber-containing material during the subsequent compressing. For this purpose, steam is introduced into a cavity 36 after the fiber-containing material has been introduced into the cavity 36. Steam is preferably introduced under pressure. For this purpose, water vapor can be introduced in the at least partially closed state of the molding tool 30. In further embodiments, steam can be introduced directly into the fiber layer through channels and openings in first molding surfaces 37 and/or second molding surfaces 45 in the closed state of the molding tool. Suitable pressures are in the range from 1 to 25 bar, wherein the pressure depends on a plurality of factors (dimensions and geometry of the molded part 200 to be produced; layer thickness of the fiber layer 80, fiber-containing material as preform, mat or loose fibers, properties of the fiber-containing material, etc.). The introduction of moisture by means of steam has proven to be a very efficient method to quickly bring the moisture into the fibers of the fiber-containing material. In further embodiments, a molding device 100 can have a tool with a plurality of cavities 36 and corresponding molding elements 44 (see FIGS. 3 to 6). In yet further embodiments, a molding device 100 can also have a preform station in which preforms are generated. For this purpose, in further embodiments, molding devices 100 can additionally or alternatively have a storage container for moldable material. Finally, a molding device 100 can have an apparatus for removing and for further processing molded parts 200.

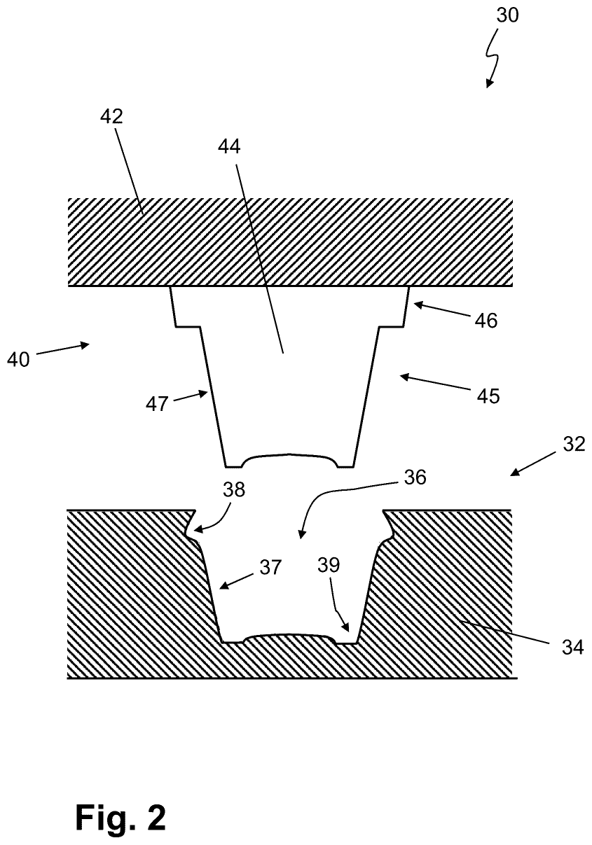

FIG. 2 shows a schematic representation of a molding tool 30 for producing molded parts 200, according to some embodiments. The molding tool 30 has a first tool component 32 and a second tool component 40, which have a first tool plate 34 and a second tool plate 42, respectively. The tool plates 34 and 42 can, for example, be made of a metal or a metal alloy. In further embodiments (not shown), a first tool plate 34 can have a plurality of cavities 36 which are arranged in the tool plate 34. In contrast to the exemplary embodiments, one or more molds with cavities 36 can be arranged on a tool plate 34. Such molds can, for example, be replaceably connected, for example screwed, to the tool plate 34.

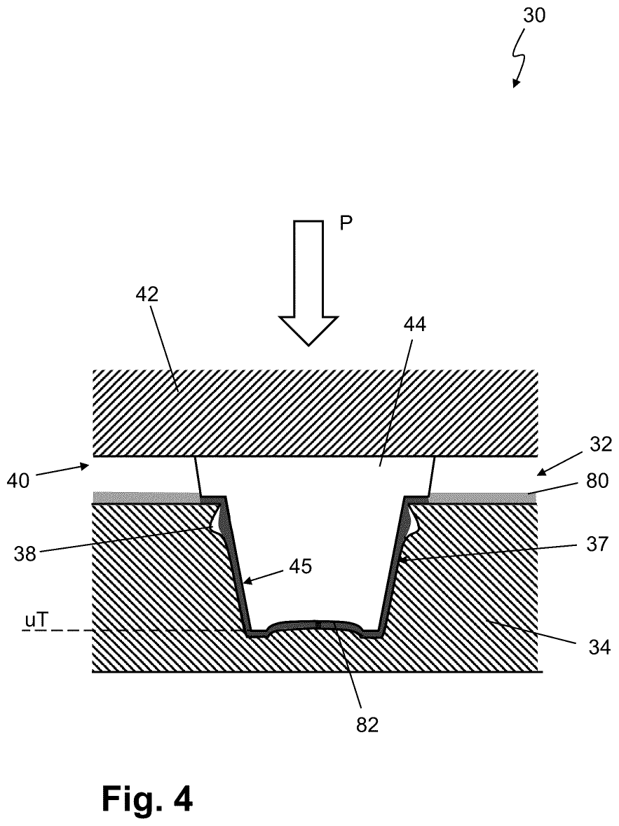

The cavity 36 has a shaping first molding surface 37. The first molding surface 37 defines the outer shape of the molded part 200 to be produced, which is a rotationally symmetrical body in the exemplary embodiment shown. In further embodiments, non-rotationally symmetrical molded parts can also be produced in correspondingly shaped cavities. The first molding surface 37 has a circumferential undercut 38 in the upper region and a circumferential edge region 39 in a lower bottom region. The surface of the tool plate 34 directly adjacent to the cavity 36 can form an annular molding surface which serves to form an edge 230 of a molded part 200, as schematically shown in FIGS. 4-6, and thus can also be part of the first molding surface 37. In further embodiments, the surface of the first molding surface 37 can have an anti-adhesion coating and/or be designed to reduce the adhesive effect. Heating devices can be provided below the first molding surface 37 and/or within the first tool plate 34, which heating devices can be controlled by a controller 10 in order to heat the first tool plate 34 and thereby the first molding surface 37. By controlling the temperature of the first molding surface 37, the deformation of an introduced material (for example, fiber-containing material; polymer film) can be supported and influenced in a targeted manner.

A molding element 44 is arranged on the second tool plate 42 and is aligned with the cavity 36 arranged below it in such a way that the molding element 44 can be inserted into the cavity 36. The molding element 44 can, for example, be connected, for example screwed, to the tool plate 42 by corresponding means. In further embodiments with a plurality of cavities 36, a plurality of corresponding molding elements 44 are arranged on the tool plate 42.

The molding element 44 is a molded body with an upper molding region 46 and a molding region 47 that is inserted. The molded body is reversibly or irreversibly connected to the second tool plate 42 in a suitable manner by the upper molding region 46. The surface of the molding region 47 that is inserted forms the second molding surface 45. Analogously to an annular surface as part of the first molding surface 37, the surface of the upper molding region 46 opposite this annular surface of the first tool body 34 can also form a part of the second molding surface 45. According to the embodiment of the cavity 36 for rotationally symmetrical molded parts 200, the molding element 44 is also rotationally symmetrical in the exemplary embodiment shown, at least in the region which is required for molding molded parts 200. In the exemplary embodiment, this applies to the molding region 47 that is inserted.

In the exemplary embodiment shown, the molding element 44 has a flexible material at least in the region of the second molding surface 45. Such a material is used as a flexible material that has the required properties in order to be deformed at a determinable pressure on the molded body within the cavity 36 if, after compressing the introduced fiber-containing material against the first molding surface 37, overpressing takes place via the molding element 44. It is essential here that such a flexible material is used in this way and at the locations such that a targeted deformation of the flexible material can take place by overpressing. Alternatively, the choice and design of one or more flexible materials in the region of the second molding surface 45 and/or within the molded body of the molding element can be selected in accordance with the degree of deformation of a flexible material and the required deformation by overpressing.

Suitable materials for the flexible material are, for example, thermoplastic elastomers or silicones. For influencing the deformability, additives can be introduced in the flexible materials. Alternatively or additionally, by introducing elements made of another material, for example a wire ring or wire mesh, the deformation in this region can be adapted and thereby be smaller than in the portion of a flexible material without such elements. Furthermore, weak points can additionally or alternatively be formed in a flexible material. Weak points can be, for example, regions of the flexible material with free spaces, wherein the free spaces can extend, for example, annularly concentrically to the vertical axis through the cavity 36 and/or in a straight line along the second molding surface 45. Such free spaces can, for example, also be provided in portions as “gas/air bubbles” within the flexible material. In further embodiments, such weak points can also be designed in that the flexible material has a lower density in these portions.

When compressing the fiber-containing material introduced into the cavity 36, the flexible material causes the fiber-containing material to be pressed against the first molding surface 37. The fiber-containing material is thereby compressed between the first molding surface 37 and the second molding surface 45. In the region of the undercut 38, at a normal pressure (P1) on the fiber-containing material via the molding element 44, no compressing of the fiber-containing material into the undercut 38 is carried out, since the shape of the molding element 44 allows no pressing into the undercut 38 (see FIG. 4). In order to press the fiber-containing material into the undercut 38 and to compress it there just as in the remaining region of the cavity 36, the molding element 44 is overpressed (P2), as described below, so that the flexible material of the molding element 44 located in the region of the undercut 38 is deformed and can thereby only escape in the direction of the undercut 38, wherein P1<P2. The deformation due to the escape movement then results in pushing of the fiber-containing material into the undercut 38 and in compressing of said material there. Since, in the case a molding element 44 with a second molding surface 45 that completely has a flexible material on its surface, the flexible material cannot escape in the remaining region, no further deformation takes place there.

For compressing fiber-containing material, the tool plate 34 and the tool plate 42 are movable relative to one another, so that the molding element 44 can be inserted into the cavity 36. In a first molding step, the molding region 47 that is inserted is introduced into the cavity 36 and the fiber-containing material is compressed. Subsequently, overpressing the molding element 44 takes place, wherein a deformation of the flexible material occurs in the region of the undercut 38 and the flexible material presses the fiber-containing material into the undercut 38 and compresses it there. Corresponding drives and apparatuses, for example toggle levers, which can be controlled via the controller 10, can be provided for displacing the two tool plates 34 and 42 for compressing fiber-containing material and for overpressing.

FIG. 3 shows a schematic representation of the molding tool 30 from FIG. 2 after the introduction of a moldable material, according to some embodiments. In the exemplary embodiment shown, a loose fiber layer 80 is introduced. The fiber layer 80 be made of a plurality of loose fibers which have only a low bond with one another, so that the fiber layer 80 is designed in the manner of a nonwoven. Such a fiber layer 80 can also be referred to as “fluff pulp,” which means very soft fiber mats which are used, for example, for diapers or the like. The fiber layer 80 referred to herein can thereby be designed corresponding to such fiber mats and have corresponding properties but differ in the type of fibers contained. For example, the loose fiber layer 80 can have comparatively soft fibers from a natural original material (for example, natural fibers made of cellulose) with a fiber length between 0.1 and 5 mm, wherein the fibers only rest on one another and are neither thermally nor otherwise compressed or connected.

The material used can be determined in accordance with the molded part 200 to be produced and its properties. Furthermore, additives can be provided which influence the properties of a molded part 200 (for example, barrier properties, etc.). Furthermore, instead of a loose fiber layer 80, a preform made of loose fibers or pre-pressed fibers with a slight bond can be introduced into the cavity 36.

The introduced fiber layer 80 has a low moisture content and can therefore substantially be classified as a “dry” fiber layer. In further embodiments, the fibers of the fiber layer 80 can also be applied to the surface of the first tool plate 34 and/or the first molding surface 37 and only form a fiber layer 80 on the surface.

In the state shown in FIG. 3, the molding tool 30 is in the open state, wherein the first tool plate 34 and the second tool plate 42 are spaced apart from one another, so that the cavity 36 is exposed to introduce the fiber layer 80. After the fiber layer 80 has been introduced, the first tool plate 34 and the second tool plate 42 are displaced relative to one another, wherein in FIG. 3 the upper second tool plate 42 is pressed downwards, for example, by a toggle lever and a corresponding drive in accordance with control commands by the controller 10, as indicated schematically by the arrow P.

FIG. 3 schematically indicates that the fiber layer 80 is inserted at least slightly into the undercut 38 during and/or after it is introduced. However, this cannot always be achieved or is not desired in further embodiments, so that the arrangement of the fiber layer 80 shown shows only one example and the arrangement is not limited thereto.

FIG. 4 shows a schematic representation of the molding tool 30 in a first molding step after the fiber layer 80 has been introduced into the cavity 36, according to some embodiments. A pressure P1 is thereby exerted by the second tool plate 42. As a result, the fiber layer 80 is compressed in the region of the first molding surface 37, so that a pre-pressed fiber layer 82 is generated. For this purpose, the molding element 44 has been displaced downwards until a bottom dead center uT has been reached. For example, the bottom dead center uT can relate to a lower molding surface 48 of the molding element 44. The pressure for compressing the fiber-containing material continues to be maintained in this case. This leads to the fiber-containing material being compressed and the fiber layer 80 being compacted into a fiber layer 82 at least in regions, wherein the fibers enter into a bond. The pressure on the molding element 44 is only so large that the fibers of the fiber layer 80 can be compressed into a pre-pressed fiber layer 82, but the flexible material of the second molding surface 45 is substantially not deformed.

The fibers of the fiber layer 80 which are located outside the region between the first molding surface 37 and the second molding surface 45 are not deformed or compressed.

After reaching the bottom dead center uT, the molding element 44 is then overpressed in a second molding step. For this purpose, a pressure P2 that is higher than the pressure P1 applied in the first molding step is applied by the second tool plate 42 and thus the molding element 44 is overpressed. The overpressing causes a deformation of the flexible material in a region 49, which material can execute a compensating movement within the cavity 36 only in the direction of the undercut 38. As a result, the overpressing ensures that the fibers of the fiber layer in the region of the undercut 38 are pressed into the undercut 38 by the deformed flexible material and are compressed there at a further pressure so that the fiber-containing material is compressed at least as strongly in the undercut 38 as the fibers of the pre-pressed fiber layer 82. A further overpressing ultimately ensures that the fibers are compacted in a pressed fiber layer 84 in all regions and have the final compaction of the individual fibers.

In order to be able to carry out overpressing, the molding element 44 has a flexible material at least over the entire surface of the molding region 46 that is inserted, or the molding element 44 can be compacted in the interior, for example, so that a deformation can also take place, for example, in lateral regions of the second molding surface 45. For compacting, the molding region 46 that is inserted can have, for example, two inner support bodies which are spaced apart from one another by a spring element. The support bodies are not deformable. On the outer side, the molding region 46 that is inserted has a flexible material. During overpressing, an upper support body is then displaced relative to a lower support body without the bottom of the molding region 46 that is inserted having to be compressed. To ensure that the flexible material does not sag between the support bodies, the support bodies can, for example, be designed like a sleeve or have a tooth structure with meshing elements which provide compensation with simultaneous support.

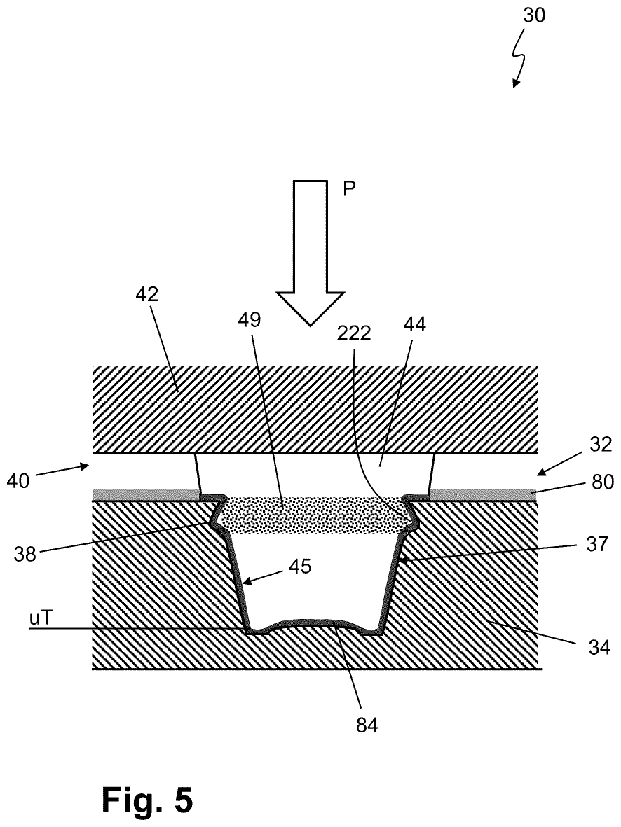

FIG. 5 shows a schematic representation of the molding tool 30 after the second molding step, according to some embodiments. In the region 49, the flexible material is pressed into the undercut 38 and, as in the remaining region between the first molding surface 37 and the second molding surface 45, has compressed the fiber-containing material of the original loose fiber layer 80 into a fiber layer 84.

After the second molding step, the overpressing is ended so that the flexible material returns to its original, non-deformed starting position. The formed bead 222 remains in the compressed fiber layer 84 of the molded part 200. The second tool plate 42 is then removed from the cavity 36, and the molded part 200 with the bead 222 can be removed from the cavity 36.

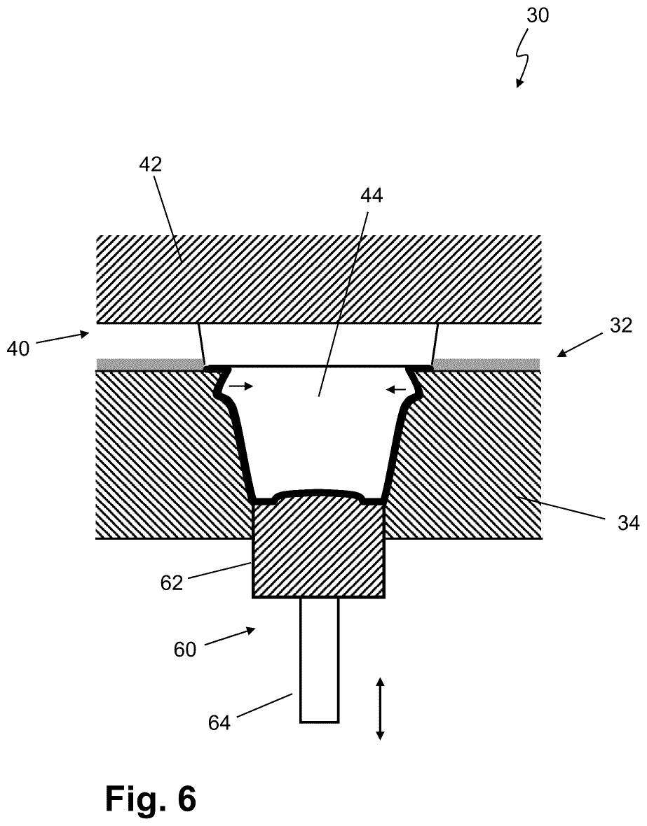

The molded part 200 can be brought out in various ways. For example, the molding tool 30 can have an ejector 60. FIG. 6 shows a schematic representation of a molding tool 30 of a further embodiment which has an ejector 60. The ejector 60 is connected to an ejector rod 64 which, as shown in FIG. 6, can be relatively displaced in the direction of the cavity 36. The ejector rod 64 is connected to a bottom element 62 which, in the embodiment shown, forms a bottom of the cavity 36. After the second molding step, the ejector 60 can be displaced vertically upwards, wherein the molded part 200 is ejected. For this purpose, the second tool plate 42 is displaced upwards beforehand in order to enable the ejection. During ejection, the displaceable bottom element 62 pushes the molded part 200 out of the cavity 36, wherein the bead 222 of the molded part is briefly compacted in the region of the undercuts 38, as indicated by the arrows directed toward one another. According to the formation of the bead 222, such an ejection can generally take place without problems or damage to the molded part 200. Such ejection processes are customary in the case of plastics parts with undercuts.

FIG. 7 shows a schematic representation of a molded part 200 as a finished product made of a fiber material, produced according to a manufacturing process described herein using a molding tool 30 according to the described embodiments. After the molding, the molded part 200 made of fiber-containing material can, for example, have a residual moisture content of 1 to 7 wt. %.

The molded part 200 has a bottom 210 and a circumferential side wall 220 extending from the bottom 210 and running relatively steeply from the bottom 210. A bead 222 extends circumferentially in the upper region of the side wall 220. At the upper end of the side wall 220, the molded part 200 has an edge 230 that runs substantially parallel to the bottom 210. In the exemplary embodiment shown, the wall thickness of the molded part 200 is the same everywhere in the bottom 210, in the side wall 220, in the bead 222 and in the edge 230. The molded part 200 can be used, for example, as a cup in the area of food packaging, as a flower pot or in another field.

FIG. 8 shows a schematic representation of a second tool component 40 of a molding tool 30 in yet further embodiments. In one embodiment, the molding element 44 has a first material 50 in the region that is inserted and a second material 52 different from the first material 50 in the region 49 which can be deformed by overpressing. The second material 52 is a flexible material which can be deformed by overpressing. The first material 50 can, for example, be a non-deformable material or a material with weaker deformability compared to the second material 52. The first and the second material 50, 52 can also differ by weak points, reinforcements or other measures influencing the properties of the materials.

Additionally or alternatively, a molding element 44 can have a support body 56 which is coated on its outer side with a flexible material which can be deformed during overpressing. The support body 56 itself is not deformable and for this purpose can be made, for example, of a metal or a metal alloy. The molding element 44 can, for example, be connected, for example, screwed, to a second tool plate 42 via the support body 56. For this purpose, the support body can have an opening with a thread or a protruding threaded rod on the side facing the second tool plate 42, which opening can be connected to corresponding elements of the tool plate 42.

In further embodiments, for example during the deformation of plastics films, compressed air can be introduced in order to support the deformation. For this purpose, corresponding channels and openings can be provided in the molding element 44, for example. Alternatively, a region of the second molding surface 45 can also be additionally deformed (“inflated”) by compressed air in order to support the deformation. This can be used for fiber-containing material and plastics films (with and without openings). Finally, openings for suctioning a film can also be provided in the first molding surface 37 in order to support the molding process.

In further embodiments, the formation of a molding element 44 with a flexible material provided in the contact region between the first tool component 32 and the second tool component 40 can additionally bring about a sealing of the cavity 36 or the molding space by the flexible material, so that no escape of fibers and/or (molding) air can occur.

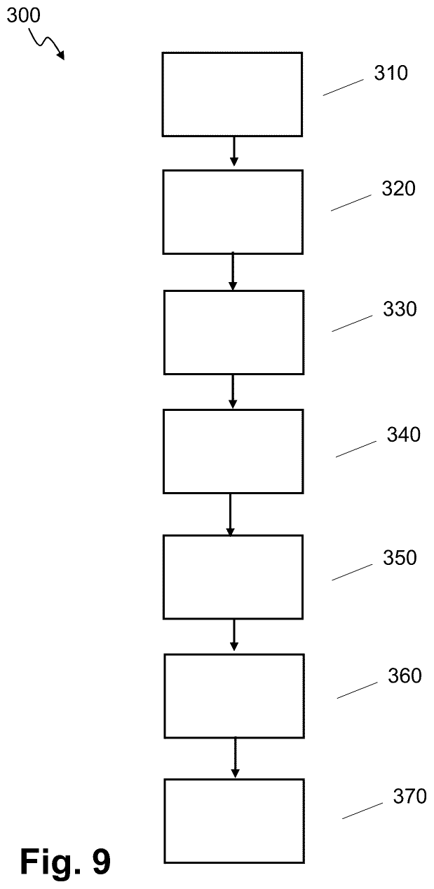

FIG. 9 shows a method 300 for producing a molded part 200 using a molding tool 30, according to some embodiments. In a first method step 310, moldable material is provided. Depending on the type of material (fiber-containing material, plastics film), the moldable material can be provided in different ways. The provision can thus include the production and/or processing of a moldable material.

In a subsequent method step 320, moldable material is supplied. For example, in the production of molded parts 200 made of a plastics material, the material can be supplied as a film web. The same applies to the production of molded parts 200 made of films with a net-like structure. A plastics film can, for example, be brought between the tool plates 34 and 42, wherein the film is not yet introduced into a cavity 36. Fiber-containing material can be supplied via a material web which can be produced, for example, in an upstream method step.

In a subsequent method step 330, the moldable material is introduced into the cavity 36 of at least one molding tool 30. The introduction of moldable material can take place, for example, by directly introducing (e.g. blowing in) loose fibers into the cavity 36. Alternatively, a web (film, fiber layer) can be pressed into the cavity 36 by the molding element 44, as is known in thermoforming via a stretching aid or molding punch.

In a method step 340, the moldable material is then compressed into the cavity 36 by pressing the molding element 44. Subsequently, in a method step 350, overpressing of the molding element 44 takes place after a bottom dead center point uT has been reached, so that a flexible material of the molding element 44 is deformed and thereby presses moldable material into free regions, such as undercuts 38, and compresses it there. The pressure on the molding element 44 can take place in two separate steps or continuously, wherein the pressure on the molding element 44 is increased until the complete deformation and the compressing of the moldable material are completed. The pressure is then reduced and the molding tool 30 is opened in a method step 360. Subsequently, in a method step 370, the molded part 200 produced in the cavity 36 is ejected. During compressing and already when the moldable material is introduced into the cavity 36, the cavity can be temperature-controlled in order to support the molding process.

The above sequence can then be repeated for a new molded part 200.

With the embodiment described herein, molded parts can advantageously be produced using simple means, and even undercuts 38 can be realized without complicated tool designs and movement sequences. In the production of molded parts made of a plastics film, introducing molding air or generating a vacuum can even be dispensed with completely, so that the molding tool can be further simplified, and the control is significantly simplified. In the case of fiber-containing materials, molded parts 200 which can experience a reduction in the wall thickness by overpressing of the molding element 44 can be generated. In particular, compensation for a natural reduction of the thickness can thus be taken into account.

### LIST OF REFERENCE NUMBERS

10 Controller
20 Supply device
30 Molding tool
32 First tool component
34 First tool plate
36 Cavity
37 First molding surface
38 Undercut
39 Edge region
40 Second tool component
42 Second tool plate
44 Molding element
45 Second molding surface
46 Upper molding region
47 Molding region that is inserted
48 Lower molding surface
49 Region
50 First material
52 Second material
56 Support body
60 Ejector
62 Bottom element
64 Ejector rod
80 Fiber layer
81 Bulge
82 Fiber layer
84 Fiber layer
100 Molding device
200 Molded part
210 Bottom
220 Side wall
222 Bead
230 Edge
300 Method
310 Method step
320 Method step
330 Method step
340 Method step
350 Method step
360 Method step
370 Method step

1. A molding tool for producing molded parts from a moldable material with at least one first tool component and at least one second tool component, wherein
the first tool component has a cavity, into which moldable material can be introduced,
the second tool component can be introduced into the cavity of the first tool component to produce a molded part,
the second tool component has a second molding surface, via which material moldable in a closed state of the molding tool can be pressed against a corresponding first molding surface of the cavity of the first tool component, and
the second tool component has at least partially a flexible material which forms at least one portion of the second molding surface, wherein the flexible material can be deformed in the closed state of the molding tool by overpressing of the second tool component after reaching a bottom dead center in the cavity in order to press the moldable material against the first molding surface.

2. The molding tool according to claim 1, wherein the cavity has at least one undercut and the moldable material can be pressed into the undercut of the cavity by the flexible material of the at least one portion by means of overpressing of the second tool component.

3. The molding tool according to claim 1, wherein the second molding surface at least partially has openings.

4. The molding tool according to claim 1, wherein a molding element of the second tool component that is inserted into the cavity of the first tool component is made completely of the flexible material.

5. The molding tool according to claim 1, wherein a molding element of the second tool component that is inserted into the cavity of the first tool component is solid.

6. The molding tool according to claim 5, wherein the molding element has internal support structures.

7. The molding tool according to claim 6, wherein the support structures influence a deformation of the second molding surface during overpressing.

8. The molding tool according to claim 1, wherein an entirety of the second molding surface has the flexible material that surrounds an inner core made of a non-deformable material.

9. The molding tool according to claim 1, wherein the flexible material has reinforcements and/or weak points that influence the deformability of the flexible material during overpressing.

10. The molding tool according to claim 1, wherein the flexible material includes different materials that differ in terms of deformability of the flexible material during overpressing.

11. The molding tool according to claim 1, wherein the second molding surface comprises at least two portions made of the flexible material that differ in terms of deformability of the flexible material during overpressing.

12. The molding tool according to claim 1, wherein the flexible material includes silicone and/or thermoplastic elastomers.

13. The molding tool according to claim 1, wherein the first tool component and/or the second tool component can be heated by at least one heating device.

14. A method for producing molded parts from a moldable material using a molding tool having at least one first tool component and at least one second tool component, wherein the first tool component has a cavity with a first molding surface, and wherein the at least one second tool component has a second molding surface and at least partially a flexible material which forms at least one portion of the second molding surface, the method comprising the following steps:
introducing a moldable material into the cavity of the at least one first tool component,
introducing the at least one second tool component into the cavity of the at least one first tool component by relative displacement of the at least one first tool component and the at least one second tool component, wherein the second molding surface of the at least one second tool component moves the moldable material at least in regions against the first molding surface, and
overpressing of the at least one second tool component after reaching a bottom dead center within the cavity, whereby the flexible material forming at least one portion of the second molding surface is deformed, and through the deformation the flexible material presses the moldable material against a corresponding portion of the first molding surface.

15. The method according to claim 14, wherein the cavity has at least one undercut and the moldable material is pressed into the undercut of the cavity by the flexible material of the at least one portion of the second molding surface during overpressing.

16. The method according to claim 14, wherein after the molded part has been molded in the cavity, the overpressing is ended, whereby the flexible material once again assumes its shape that was present before overpressing and then the at least one second tool component is moved out of the cavity.
